(19) United States
(12) Patent Application Publication
(10) Pub. No.: US 2017/0095934 A1
(43) Pub. Date: Apr. 6, 2017

(54) HUMANOID ROBOT JOINT MECHANISM

(71) Applicant: NABTESCO CORPORATION, Tokyo (JP)

(72) Inventors: Hongyou WANG, Mie (JP); Yoshiaki MAKIZOE, Mie (JP); Hideshi SHIMADA, Mie (JP)

(21) Appl. No.: 15/128,034

(22) PCT Filed: Mar. 19, 2015
(86) PCT No.: PCT/JP2015/058342

§ 371 Date: Sep. 21, 2016

(30) Foreign Application Priority Data
Apr. 3, 2014 (JP) 2014-077216

(51) Int. Cl. B25J 17/02; B25J 9/10

(52) U.S. Cl. CPC B25J 17/0241; B25J 9/102; Y10S 901/28; Y10S 901/25

(57) ABSTRACT

A joint mechanism includes: a first member; a second member that includes a first portion and second portion; a gear device including a crank shaft on which a first eccentric portion is formed, a first oscillating gear that has first external teeth and a first insertion hole, a carrier that retains the crank shaft, and an external cylinder that has internal-tooth pins. The carrier and the external cylinder are configured to be displaced coaxially due to oscillation of the first oscillating gear. The joint mechanism further includes a first fixing member that fixes the external cylinder to the first member, and a second fixing member that fixes the carrier to the second member. The second fixing member includes a one-side fixing member that fixes the carrier to the first portion and an other-side fixing member that fixes the carrier to the second portion.

### TECHNICAL FIELD

The present disclosure relates to a humanoid robot joint mechanism.

### BACKGROUND

There has been known a humanoid robot joint mechanism in which a first member is rotatable relative to a second member with a reducer interposed therebetween. Patent Document 1 disclosed a joint mechanism with a harmonic Drive™ which is a strain wave gearing that serves as a reducer disposed between an upper-half torso and a lower-half torso. In this joint mechanism, the strain wave gearing include an annular internal-tooth gear that is fixed and an elastic external-tooth gear that meshes with the annular internal-tooth gear to rotate and serves as an output gear. With the joint mechanism, an upper shaft of the lower-half torso is fixed to the annular internal-tooth gear and a torso cover of the upper-half torso is fixed to the elastic outer-tooth gear thereby making the upper-half and lower-half torsos rotatable relative to each other.

In recent years, it is desired to increase a torque that is transmitted to the first or second member from the reducer in the humanoid robot joint mechanism. However, Patent Document 1 adopts the strain wave gearing that cannot bear a high load as a reducer. Because the output gear of the strain wave gearing is the elastic external-tooth gear, the elastic external-tooth gear has a limited area where the upper-half torso cover can be attached and therefore it is difficult to increase the torque transmitted from the strain wave gearing to the upper-half torso.

### RELEVANT REFERENCES

### Patent Literature

Patent Document 1: Japanese Patent Application Publication No. 2005-161438

### SUMMARY

One object of the disclosure is to provide a humanoid robot joint mechanism that overcomes the above-mentioned drawback.

A joint mechanism of a humanoid robot according to one aspect of the disclosure includes: a first member that forms a first region of the humanoid robot; a second member that forms a second region of the humanoid robot and includes first and second portions which face to each other; and a gear device. The gear device includes: a crank shaft on which an eccentric portion is formed; an oscillating gear that has external teeth and an insertion hole into which the eccentric portion is inserted; a carrier that retains the crank shaft rotatably; and an external cylinder that is disposed on radially outer side of the carrier and that has internal teeth meshing with the external teeth of the oscillating gear. The carrier and the external cylinder are configured to be displaced coaxially and relatively to each other due to oscillation of the oscillating gear that is generated by rotation of the crank shaft, and the gear device is disposed between the first portion and the second portion. The joint mechanism further includes a first fixing member that fixes the external cylinder to the first member; and a second fixing member that fixes the carrier to the second member. The second fixing member includes a one-side fixing member that fixes the carrier to the first portion of the second member and an other-side fixing member that fixes the carrier to the second portion of the second member.

### BRIEF DESCRIPTION OF THE DRAWINGS

FIG. 1 is a schematic elevation view of a humanoid robot according to an embodiment.

FIG. 2 is a schematic sectional view of a main portion of a joint mechanism Y according to the embodiment.

FIG. 3A is an elevation view of a first portion 210 of the joint mechanism Y1 according to the embodiment to illustrate its internal wall and a region where a carrier is situated. FIG. 3B is an elevation view of a second portion 220 of the joint mechanism Y1 according to the embodiment to illustrate a region where a carrier is situated.

FIG. 4 illustrates Modification Example 1 of the joint mechanism Y1 according to the embodiment showing the same portion as FIG. 2.

FIG. 5 illustrates Modification Example 2 of the joint mechanism Y1 according to the embodiment showing the same portion as FIG. 2.

FIG. 6 illustrates Modification Example 3 of the joint mechanism Y1 according to the embodiment showing the same portion as FIG. 2.

FIG. 7 illustrates Modification Example 4 of the joint mechanism Y1 according to the embodiment showing the same portion as FIG. 2.

### DESCRIPTION OF THE EMBODIMENT

An embodiment of the invention will now be described with reference to the attached drawings. The drawings referred below are given for the purpose of illustration and the main parts are schematically illustrated Therefore a joint mechanism Y1 of a humanoid robot X1 according to the embodiment may include any parts which are not shown in the drawings.

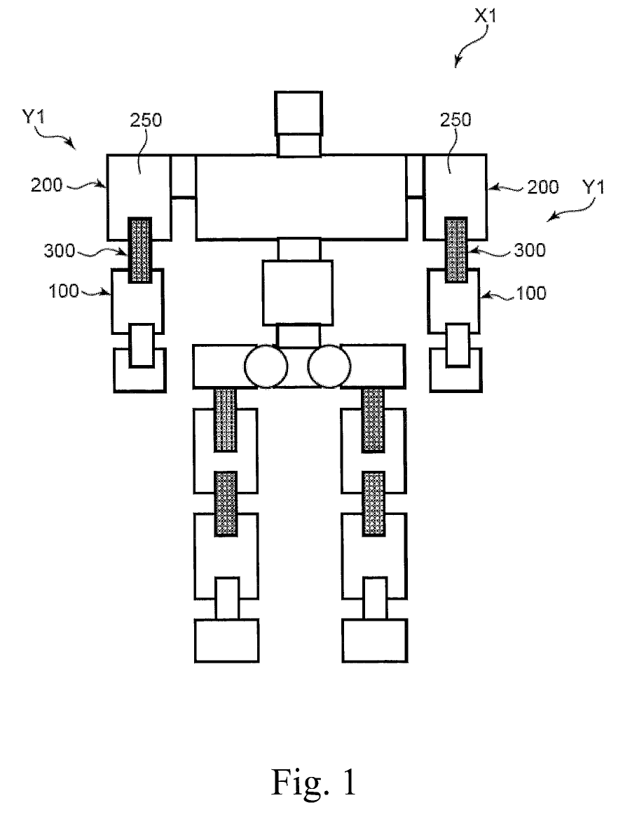

Referring to FIG. 1, the humanoid robot X1 according to the embodiment is a robot with a body shape resemble to the human body and with a plurality of joints. The humanoid robot X1 may include a joint mechanism Y. The joint mechanism Y1 may include a first member 100 that forms a body part from a hand to an elbow, a second member 200 that forms a body part from the elbow to a shoulder, and a gear device 300 that forms the elbow and allows the first member 100 and the second member 200 to rotate relative to each other. The embodiment where the joint mechanism Y1 forms the elbow joint of the humanoid robot X1 will be hereunder described. However, the joint mechanism Y1 may form any other joints of the humanoid robot X1. Moreover, in the embodiment, the joint mechanism Y1 is used for the humanoid robot X1 that has an appearance of human body. However, the invention is not limited to this and the joint mechanism Y1 may also be used for other humanoid robots including one with an appearance of anthropoid ape.

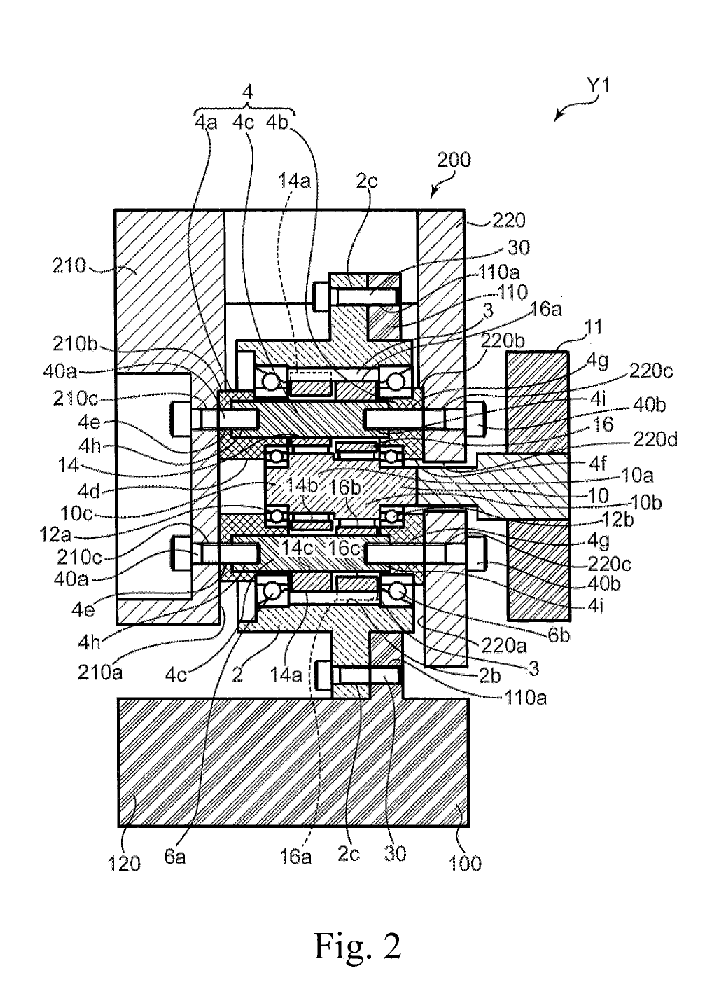

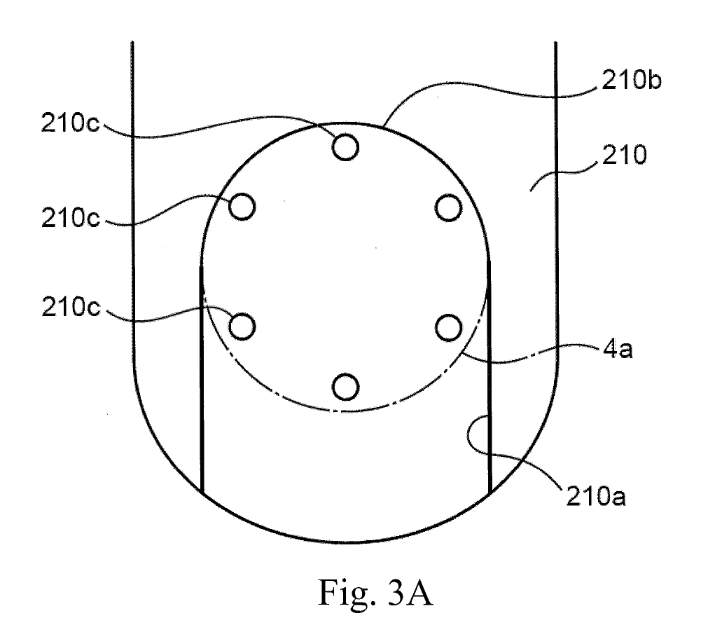

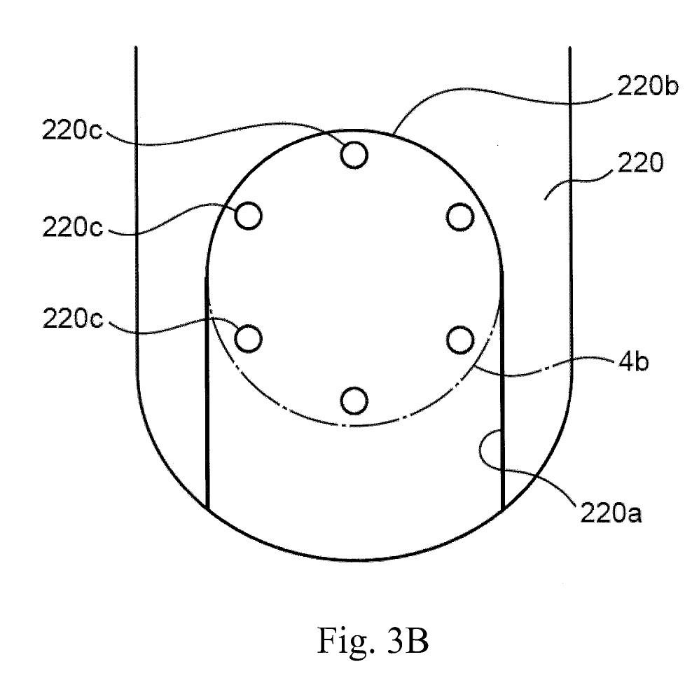

The first member 100, the second member 200, and the gear device 300 included in the joint mechanism Y1 will now be described with reference to FIGS. 2 and 3.

The first member 100 may include a main body 120 and an attachment 110. The main body 120 is a main portion that forms a body part that extends from the hand to the elbow of the humanoid robot X1. The attachment 110 may extend from an edge of the main body 120 into the space between a first portion 210 and a second portion 220 which will be later described in detail, and may be attached to a hereunder-described external cylinder 2 of the gear device 300.

The second member 200 may include a main body 250, the first portion 210, and the second portion 220. The main body 250 is a main portion that forms a body part that extends from the elbow to the shoulder of the humanoid robot X1. The first portion 210 and the second portion 220 may extend from an edge of the main body 250 toward the first member 100 and face to each other with a gap interposed therebetween. The first portion 210 may include a first guide portion 210a that is formed as a groove and provided on an inner wall of the first portion 210 that faces the second portion 220. The second portion 220 may include a second guide portion 220a that is formed as a groove and provided on an inner wall of the second portion 220 that faces the first portion 210. The first guide portion 210a may include a first stopper 210b and the second guide portion 220a may include a second stopper 220b. The first stopper 210b and the second stopper 220b may have a shape that conforms to the outer edge of a carrier 4 of the gear device 300.

The gear device 300 may be guided along the first guide portion 210a and the second guide portion 220a to be inserted in a predetermined insertion direction into the space between the first portion 210 and the second portion 220. The gear device 300 inserted in the space may be positioned therein such that the outer edge of the carrier 4 abuts the first stopper 210b and the second stopper 220b.

Note that the first and second guide portions 210a, 220a may be formed in any shape other than a groove shape, for example, they may be formed as rails on the inner walls of the first and second portions 210, 220.

The gear device 300 is used as a reducer that is provided in an elbow joint of the humanoid robot X1. The gear device 300 may have a reduction ratio, for example, ranging from 80 to 200. The gear device 300 may be disposed in the space between the first portion 210 and the second portion 220 of the second member 200. More specifically, the gear device 300 may be disposed in the space between the first portion 210 and the second portion 220 such that the carrier 4 abuts the first stopper 210b and the second stopper 220b.

The gear device 300 may be a center-crank type gear device. In the gear device 300, a crank shaft 10 disposed at the center of the gear device 300 is rotated in response to input from the outside and oscillating gears 14, 16 are swingably rotated in conjunction with eccentric portions 10a, 10b of the crank shaft 10. In this way, output rotations that is reduced from the input rotations can be obtained. In this manner, the first and second members 100, 200 are rotated relative to each other.

The gear device 300 may include the external cylinder 2, the carrier 4, the crank shaft 10, the first oscillating gear 14, and the second oscillating gear 16.

The external cylinder 2 forms the outer surface of the gear device 300 and has a substantially cylindrical shape. A plurality of pin grooves 2b are formed on an inner periphery of the external cylinder 2. Each pin groove 2b extends in the axial direction of the external cylinder 2 and has a semicircular cross-sectional shape along the plane orthogonal to the axial direction. The pin grooves 2b may be arranged circumferentially along the external cylinder 2 at a regular interval

The external cylinder 2 may have a plurality of internal-tooth pins 3. Each internal-tooth pin 3 is attached in the pin groove 2b respectively. More specifically, each internal-tooth pin 3 is fitted in the corresponding pin groove 2b and retained therein such that it extends in the axial direction of the external cylinder 2. In this manner, the plurality of internal-tooth pins 3 are arranged along the circumference of the external cylinder 2 at a regular interval. The internal-tooth pins 3 may mesh with first external teeth 14a of the first oscillating gear 14 and second external teeth 16a of the second oscillating gear 16.

The external cylinder 2 may have a flange portion that extends radially from the external cylinder 2 toward the outside. The flange portion may be disposed so as to overlap the attachment 110 in the axial direction of the external cylinder 2.

The major portions of the external cylinder 2 except for the internal-tooth pins 3 may be formed of a light-weight material that has a smaller density than that of the internal-tooth pins 3. In this embodiment, the major portions of the external cylinder 2 except for the internal-tooth pins 3 may be formed of aluminum and the internal-tooth pins 3 may be made of ferrous metal.

The carrier 4 may be housed within the external cylinder 2 as it is disposed coaxially with the external cylinder 2. The carrier 4 is disposed on the radially inner side of the external cylinder 2. A pair of main bearings 6a, 6b may be disposed between the carrier 4 and the external cylinder 2 such that they are separated from each other in the axial direction. The main bearings 6a, 6b allow the relative rotations of the external cylinder 2 and the carrier 4.

The carrier 4 may include a basal plate 4a, a plurality of shafts 4c, and an end plate 4b. The basal plate 4a, the shafts 4c, and the end plate 4b may be separate parts. The basal plate 4a, the shafts 4c, and the end plate 4b may by fixed to each other through second fixing members 40 which will be described later in detail. The basal plate 4a and the end plate 4b may be made of a light-weight material with a density smaller than that of the shafts 4c. In this embodiment, the basal plate 4a and the end plate 4b may be formed of aluminum and the shafts 4c may be made of ferrous metal. Note that the basal plate 4a, the shafts 4c and the end plate 4b may not be separately provided. For example, the basal plate 4a and the shafts 4a may be integrally formed and this integrated body and the end plate 4b may be separately provided,

The basal plate 4a may be disposed closer to the first portion 210 in the axial direction within the external cylinder 2. The basal plate 4a may have a circular through-hole 4d at its radial center. The basal plate 4a may contact the first stopper 210 in the radial direction of the basal plate 4a and may contact the inner wall of the first portion 210 in the axial direction of the basal plate 4a.

The end plate 4b may be disposed in the axial direction of the basal plate 4a at a predetermined distance therefrom and disposed closer to the second portion 220 in the axial direction within the external cylinder 2. The end plate 4b may have a circular through-hole 4f at its radial center. The end plate 4b may contact the second stopper 220b in the radial direction of the end plate 4b and contacts the inner wall of the second portion 220 in the axial direction of the end plate 4b. The basal plate 4a and the end plate 4b may face to each other with the first and second oscillating gears 14, 16 interposed therebetween.

Each shaft 4c may extend along the axial direction of the basal plate 4a and the end plate 4b and connect the basal plate 4a and the end plate 4b. More specifically, each shaft 4c may be disposed between the basal plate 4a and the end plate 4b and may be inserted into a first through-hole 14c and a second-through hole 16c formed in the first and second oscillating gears 14, 16, which will be later described. One end of each shaft 4c may be fitted in a corresponding concave portion formed in a surface of the basal plate 4a that faces the first oscillating gear 14. The other end of each shaft 4c may be fitted in a corresponding concave portion formed in a surface of the end plate 4b that faces the second oscillating gear 16. The plurality of shafts 4c may be arranged in the circumferential direction of the carrier 4 at a regular interval. The number of the shafts 4c may be adequately changed depending on an application of the gear device 300.

The crank shaft 10 may be disposed such that its shaft center coincides with the axial center of the external cylinder 2 and the carrier 4 in the central region of the gear device 300 and the crank shaft 10 rotates on the shaft center. More specifically, in the central region of the gear device 300, the through-hole 4d in the basal plate 4a, the through-hole 4f in the end plate 4b, a first insertion hole 14b in the first oscillating gear 14, and a second insertion hole 16b in the second oscillating gear 16 which will be later described, are communicated to each other to form a communication hole in which the crank shaft 10 is inserted. At the end portion of the crank shaft 10 situated closer to the second portion 220, provided is an input section 11 such as a pulley to which a drive force generated by an unshown motor is transmitted. More specifically, the input section 11 may be attached to the end portion of the crank shaft 10 via an input hole 220d of the second portion 220 that communicates with the through-hole 4f of the end plate 4b. The input section 11 may transmit the drive force generated by the motor to the crank shaft 10 to rotate the crank shaft 10 on its axis.

The crank shaft 10 may be supported by a pair of crank bearings 12a, 12b such that it is rotatable on its axis relative to the carrier 4. More specifically, the first crank bearing 12a may be disposed between the basal plate 4a and the one end of the crank shaft 10 that is situated close to the first portion 210 in the axial direction of the crank shaft 10. Whereas the second crank bearing 12b may be disposed between the end plate 4b and the other end of the crank shaft 10 that is situated close to the second portion 220 in the axial direction of the crank shaft 10. In this manner, the crank shaft 10 may be rotatably supported by the basal plate 4a and the end plate 4b.

The crank shaft 10 may have a shaft body 10c and the eccentric portions 10a, 10b that are integrally formed with the shaft body 10c. The first and second eccentric portions 10a, 10b may be arranged in the axial direction between the crank bearings 12a, 12b on the shaft body 10c. The first and second eccentric portions 10a, 10b may have columnar shapes and jetty radially outward from the shaft body 10c as they are arranged eccentrically to the center of the shaft body 10c. The first and second eccentric portions 10a, 10b may be arranged on the shaft with predetermined eccentricities from the shaft center and may have a phase difference of a predetermined angle from each other.

The first oscillating gear 14 may be disposed in the space between the basal plate 4a and the end plate 4b inside the external cylinder 2. The first oscillating gear 14 may have an outer diameter slightly larger than the inner diameter of the external cylinder 2. The first oscillating gear 14 may have first external teeth 14a, the first insertion hole 14b and a plurality of the first through-holes 14c. The first external teeth 14a are the wave-shaped portion continuously formed along the entire circumference of the first oscillating gear 14. The number of the first external teeth 14a may be set to a number smaller than the number of the internal-tooth pins 3. The first insertion hole 14b may be a portion where the first eccentric portion 10a is inserted and the first oscillating gear 14 may be attached to the first eccentric portion 10a via a first roller bearing in the first insertion hole 14b. Each of the first through-holes 14c may be a portion where the corresponding shaft 4c is inserted and it may have a diameter slightly larger than the outer diameter of the shaft 4c.

The second oscillating gear 16 may be disposed in the space between the basal plate 4a and the end plate 4b inside the external cylinder 2 and may be situated closer to the second portion 220 compared to the first oscillating gear 14. The second oscillating gear 16 may have an outer diameter slightly larger than the inner diameter of the external cylinder 2. The second oscillating gear 16 may have second external teeth 16a, the second insertion hole 16b and a plurality of the second through-holes 16c. The second external teeth 16a are the wave-shaped portion continuously formed along the entire circumference of the second oscillating gear 16. The number of the second external teeth 16a may be set to a number smaller than the number of the internal-tooth pins 3. The second insertion hole 16b may be a portion where the second eccentric portion 10b is inserted and the second oscillating gear 16 may be attached to the second eccentric portion 10b via a second roller bearing in the second insertion hole 16b. Each of the second through-holes 16c may be a portion where each shaft 4c is inserted and it may have a diameter slightly larger than the outer diameter of the shaft 4c.

The first and second oscillating gears 14, 16 may be swingably rotated in accordance with the eccentric rotations of the first and second eccentric portions 10a, 10b as the crank shaft 10 rotates. More specifically, the first and second oscillating gears 14, 16 may be swingably rotated with a different phase from each other such that the first and second external teeth 14a, 16a mesh with the internal-tooth pins 3.

Although the embodiment adapts the first and second oscillating gears 14, 16 with a different phase, one, three or more oscillating gears may be used

In the gear device 300 configured as described above, a drive force is transmitted to the crank shaft 10 through the input section 11 and the crank shaft 10 is rotated at a prescribed number of revolution corresponding to the drive force. The first and second oscillating gears 14, 16 are then rotated at a prescribed number of revolutions corresponding to the rotation of the crank shaft 10. At this point, the first and second oscillating gears 14, 16 may mesh with the internal-tooth pins 3 to revolve and their meshing positions may be sequentially displaced. Consequently, the external cylinder 2 and the carrier 4 may be displaced concentrically and relatively to each other.

Here, the gear device 300 may further include a plurality of first fixing members 30 and a plurality of second fixing members 40. Each of the first fixing members 30 fixes the first member 100 to the external cylinder 2. Each of the second fixing members 40 fixes the second member 200 to the carrier 4.

Each of the first fixing members 30 is a member to fix the first member 100 to the external cylinder 2. Here, the attachment 110 of the first member 100 may have a plurality of fastener holes 110a that penetrate a part of the attachment 110 in the axial direction of the external cylinder 2. The flange portion of the external cylinder 2 may have a plurality of insertion holes 2c that penetrate a part of the flange portion in the axial direction of the external cylinder 2 and that communicate with the fastener holes 110a respectively. Each first fixing member 30 may be inserted into the corresponding fastener hole 110a through the insertion hole 2c of the flange portion to fasten the flange portion of the external cylinder 2 to the attachment 110 of the first member 100.

Each of the second fixing members 40 is a member that fixes the carrier 4 to the second member 200. Each second fixing member 40 may include a plurality of one-side fixing members 40a and a plurality of other-side fixing members 40b.

Each of the one-side fixing members 40a is a member that fixes the carrier 4 to the first portion 210 of the second member 200. Here, the first portion 210 may have a plurality of insertion holes 210c that penetrate a part of the first portion 210 in the axial direction of the carrier 4. The basal plate 4a may have a plurality of insertion holes 4e that each communicate with the corresponding insertion hole 210c in the axial direction of the carrier 4 and that each penetrate the corresponding concave portion in which one end of the corresponding shaft 4c is fitted. The shafts 4c may have fastener holes 4h that communicate with the corresponding insertion holes 4e in the axial direction of the carrier 4. The one-side fixing members 40a may be each inserted into the corresponding fastener hole 4h via the insertion hole 210c and the insertion hole 4e to fasten the basal plate 4a to the first portion 210 and fasten the corresponding shaft 4c to the basal plate 4a. The one-side fixing members 40a may not fasten the shafts 4c to the basal plate 4a but fasten the basal plate 4a to the first portion 210. When the one-side fixing members 40a do not fasten the shafts 4c to the basal plate 4a, the basal plate 4a and the shafts 4c may be integrally formed from a single member or may be fastened by any other fixing members other than the one-side fixing members 40a.

In the embodiment, in the first portion 210, six insertion holes 210c may be provided along the circumference of the basal plate 4a at a regular interval as illustrated in FIG. 3A. Six one-side fixing members 40a may be provided so as to correspond the six insertion holes 210c. Note that the number of the one-side fixing members 40a may be adequately changed depending on an application of the joint mechanism Y1.

The other-side fixing members 40b fix the carrier 4 to the second portion 220 of the second member 200. Here, the second portion 220 may have a plurality of insertion holes 220c that penetrate a part of the second portion 220 in the axial direction of the carrier 4. The end plate 4b may have a plurality of insertion holes 4g that each communicate with the corresponding insertion hole 220c in the axial direction of the carrier 4 and that reach to the corresponding concave portion in which the other end of the corresponding shaft 4c is fitted. Shafts 4c may further have fastener holes 4i that communicates with the corresponding insertions hole 4g in the axial direction of the carrier 4. The other-side fixing members 40b are each inserted into the corresponding fastener hole 4i via the insertion hole 220c and the insertion hole 4g to fasten the second portion 220 to the end plate 4b and fasten the corresponding shaft 4c to the end plate 4b. The other-side fixing members 40b may not fasten shafts 4c to the end plate 4b but fasten the end plate 4b to the second portion 220. When the other-side fixing members 40b do not fasten the shafts 4c to the end plate 4b, the end plate 4b and the shafts 4c may be integrally formed from a single member or may be fastened by any other fixing members other than the other-side fixing members 40b.

In the embodiment, in the second portion 220, six insertion holes 220c may be provided along the circumference of the end plate 4b at a regular interval as illustrated in FIG. 3B. Six other-side fixing members 40b may be provided so as to correspond the six insertion holes 220c. Note that the number of the other-side fixing members 40b may be adequately changed depending on an application of the joint mechanism Y1.

In the embodiment, the one-side fixing members 40a and the other-side fixing members 40b may be arranged to face to each other in the axial direction of the carrier 4. In other words, the carrier 4 is fixed to the first portion 210 and the second portion 220 such that the one-side fixing members 40a and the other-side fixing members 40b sandwich the carrier 4 in the axial direction of the carrier 4. Note that the one-side fixing members 40a and the other-side fixing members 40b may not necessarily face to each other in the axial direction of the carrier 4 as long as the each of the one-side fixing members 40a and the other-side fixing members 40b fixes the carrier 4 to the first portion 210 and the second portion 220.

A torque transmitted from the crank shaft 10 to the carrier 4 through the first and second oscillating gears 14, 16 are then transmitted to the first portion 210 and the second portion 220 through the one-side fixing members 40a and the second fixing members 40 and thereby the second member 200 is rotated relatively to the first member 100.

As described above, in the joint mechanism Y1 of the humanoid robot X1 according to the embodiment, the first portion 210 and the second portion 220 of the second member 200 face to each other, and the gear device 300 is disposed between the first portion 210 and the second portion 220. The basal plate 4a of the carrier 4 is fixed to the first portion 210 by the one-side fixing members 40a, and the end plate 4b of the carrier 4 is fixed to the second portion 220 by the other-side fixing members 40b. In other words, the carrier 4 that serves as an output section of the gear device 300 is fixed to the second member 200 at each side of the the carrier 4 in the axial direction. Therefore, it is possible to increase the torque that is transmitted from the gear device 300 to the second member 200 through the rotation of the carrier 4. Moreover, the joint mechanism Y1 adapts, as the reducer, the gear device 300 in which the carrier 4 and the external cylinder 2 are displaced coaxially and relatively to each other due to the oscillation of the first and second oscillating gears 14, 16 that are rotated by the crank shaft 10. The gear device 300 can bear a high load comparing to the strain wave gearing so that it is possible to prevent decrease in a torque transmitted from the gear device 300 to the second member 200.

Moreover, in the joint mechanism Y1 according to the embodiment, the basal plate 4a, the end plate 4b, and the shafts 4c may be formed from separate members respectively. Therefore, the joint mechanism Y can be easily assembled. More specifically, when the joint mechanism Y is assembled, firstly the shafts 4c are inserted through the corresponding first through-holes 14c of the first oscillating gear 14 and the corresponding second through-holes 16c of the second oscillating gear 16, and then the basal plate 4a and the end plate 4b are disposed so as to sandwich the first oscillating gear 14 and the second oscillating gear 16. Subsequently, the shafts 4c and the basal and end plates 4a, 4b are connected to each other. In this way, the joint mechanism Y1 may be assembled.

Moreover, in the joint mechanism Y1 according to the embodiment, the shafts 4c to which a high load is applied from the first oscillating gear 14 and the second oscillating gear 16 are made of a rigid material, and the basal plate 4a and the end plate 4b are made of a light-weight material that has a smaller density compared to that of the shafts 4c. Therefore it is possible to provide the carrier 4 with a high strength and light weight.

Furthermore, in the joint mechanism Y1 according to the embodiment, the shafts 4c can be fixed to the basal plate 4a by the one-side fixing members 40a that fix the carrier 4 to the first portion 210. The shafts 4c can also be fixed to the end plate 4b by the other-side fixing members 40b that fix the carrier 4 to the second portion 220. Therefore even when the basal plate 4a, the end plate 4b and the shafts 4c are separate members, it is possible to fix the shafts 4c to the basal plate 4a and the end plate 4b without increasing the number of parts. Moreover, the shafts 4c and the basal plate 4a can be fixed in the process where the first portion 210 and the basal plate 4a are fixed to each other by the one-side fixing members 40a, and the shafts 4c and the end plate 4b can be fixed in the process where the second portion 220 and the end plate 4b are fixed to each other by the other-side fixing members 40b. Therefore it is possible to simplify the assembling process.

Furthermore, in the joint mechanism Y1 according to the embodiment, each of the one-side fixing members 40a is inserted into the corresponding fastener hole 4h of the shaft 4c through the insertion hole 210c provided in the first portion 210, and each of the other-side fixing members 40b is inserted into the corresponding fastener hole 4i of the shaft 4c through the insertion hole 220c provided in the second portion 220. Therefore the torque transmitted from the first and second oscillating gears 14, 16 to each shaft 4c is directly transmitted to the corresponding one-side fixing member 40a and the corresponding other-side fixing member 40b from the shaft 4c. In this way, it is possible to increase the torque transmitted to the second member 200.

Moreover, in the joint mechanism Y1 according to the embodiment, the first guide portion 210a is provided in the first portion 210 and the second guide portion 220a is provided in the second portion 220. The gear device 300 is guided by the first and second guide portion 210a, 220a to be inserted into the space between the first portion 210 and the second portion 220, and then stopped at a predetermined position. Therefore the carrier 4 and the second member 200 can be securely positioned relative to each other when the carrier 4 is fixed to the second member 200 through the second fixing members 40. In this way, it is possible to improve the assembling efficiency of the joint mechanism Y1. In the specification, the above-mentioned predetermined position refers to a position where the insertion holes 210c in the first portion 210 each correspond to and communicate with the insertion holes 4e in the basal plate 4e respectively and the insertion holes 220c in the second portion 220 each correspond to and communicate with the insertion holes 4g in the end plate 4b respectively. The first stopper 210b and the second stopper 220b are provided so as to stop the insertion of the gear device 300 at this position.

The embodiment disclosed above is an merely example and the invention is not limited to this. The scope of the invention will be defined by the appended claims not by the above-described embodiment. It is intended to cover modifications and equivalent arrangements that are within the spirit and scope of the appended claims.

For instance, various modifications can be made to the joint mechanism Y1 of the humanoid robot X1 according to the embodiment.

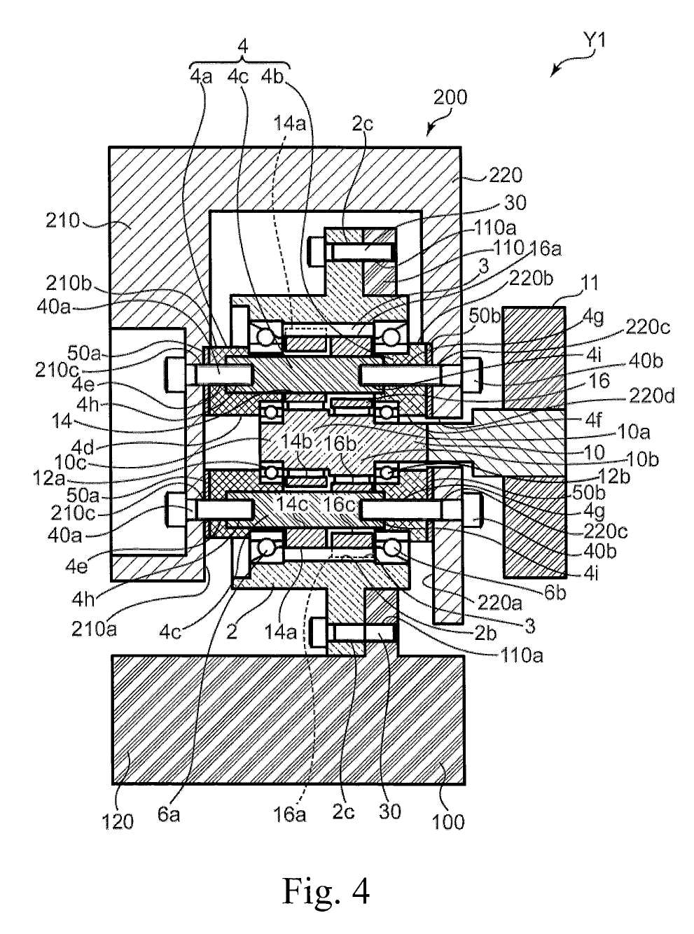

FIG. 4 illustrates Modification Example 1 of the joint mechanism Y1. Referring to FIG. 4, provided are shims 50a that are a thin flat plates to fill the gap between the inner wall of the first portion 210 and the basal plate 4a. Furthermore, provided are shims 50b that are thin flat plates to fill the gap between the inner wall of the second portion 220 and the basal plate 4a. According to such a configuration, even when the length of the carrier 4 in the axial direction is smaller than the distance between the inner wall of the first portion 210 and the inner wall of the second portion 220, the distance between the inner wall of the first portion 210 and the inner wall of the second portion 220 is not necessary adjusted in accordance with the size of the gear device 300 because the shims are provided. In this way, it is possible to improve the assembling efficiency of the joint mechanism Y1.

When the shims 50a are provided between the inner wall of the first portion 210 and the basal plate 4a and the shims 50b are provided between the inner wall of the second portion 220 and the end plate 4b like Modification Example 1 of the joint mechanism Y1 illustrated in FIG. 4, it is further possible to adjust the position of the first member 100 in the rotational axis direction. Note that only one of the shim 50a, 50b may be provided.

In Modification Example 1 of the joint mechanism Y1 illustrated in FIG. 4, a hole is provided in the shim 50a and the hole communicates with the corresponding insertion hole 210c of the first portion 210 and the insertion hole 4e of the basal plate 4e. The one-side fixing member 40a is inserted into the hole to retain the shim 50a there. A hole is provided also in the shim 50b and the hole communicates with the corresponding insertion hole 220c of the second portion 220 and the insertion hole 4g of the end plate 4b. The other-side fixing member 40b is inserted into the hole to retain the shim 50b there. In such a configuration, the shim 50a can be held by the one-side fixing member 40a that fixes the basal plate 4a to the first portion 210, and the shim 50b can be held by the other-side fixing member 40b that fixes the end plate 4b to the second portion 220. Therefore it is possible to achieve the retention of the shims 50a, 50b without increasing the number of components or processes.

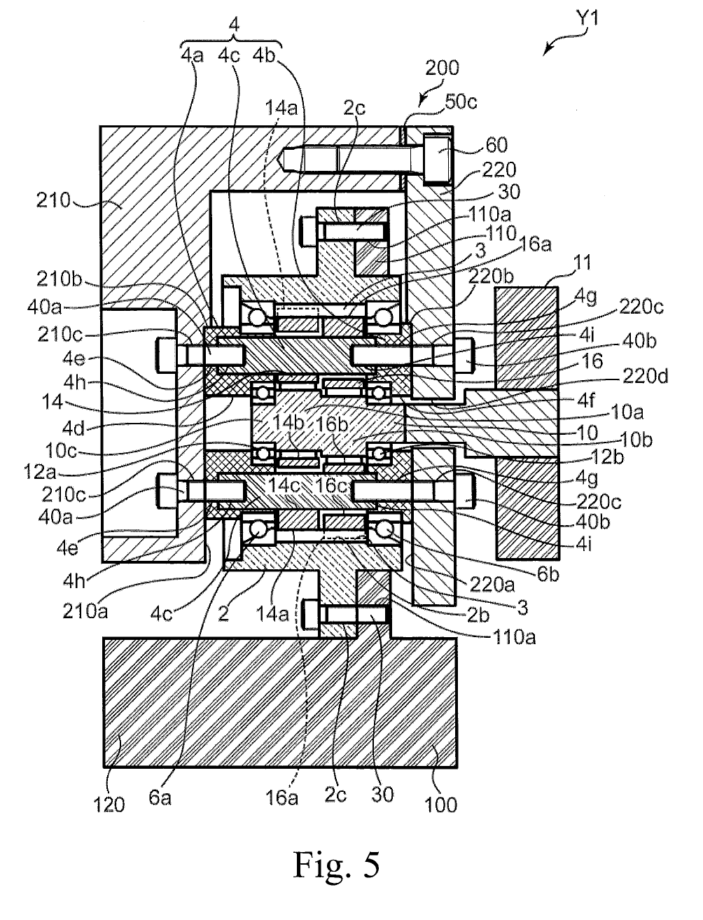

FIG. 5 illustrates Modification Example 2 of the joint mechanism Y1. Referring to FIG. 5, the first portion 210 and the second portion 220 are separate members from each other, and provided is a shim 50c that is a thin flat plate member to fill the gap between the first portion 210 and the second portion 220. The first portion 210 and the second portion 220 that are separate members are fastened to each other by a third fixing member 60 with the shim 50c provided in the gap. In this configuration, even when the length of the carrier 4 in the axial direction is relatively large, it is still possible to dispose the gear device 300 in the space between the first portion 210 and the second portion 220 by increasing the distance between the inner wall of the first portion 210 and the inner wall of the second portion 220 using the shim 50c.

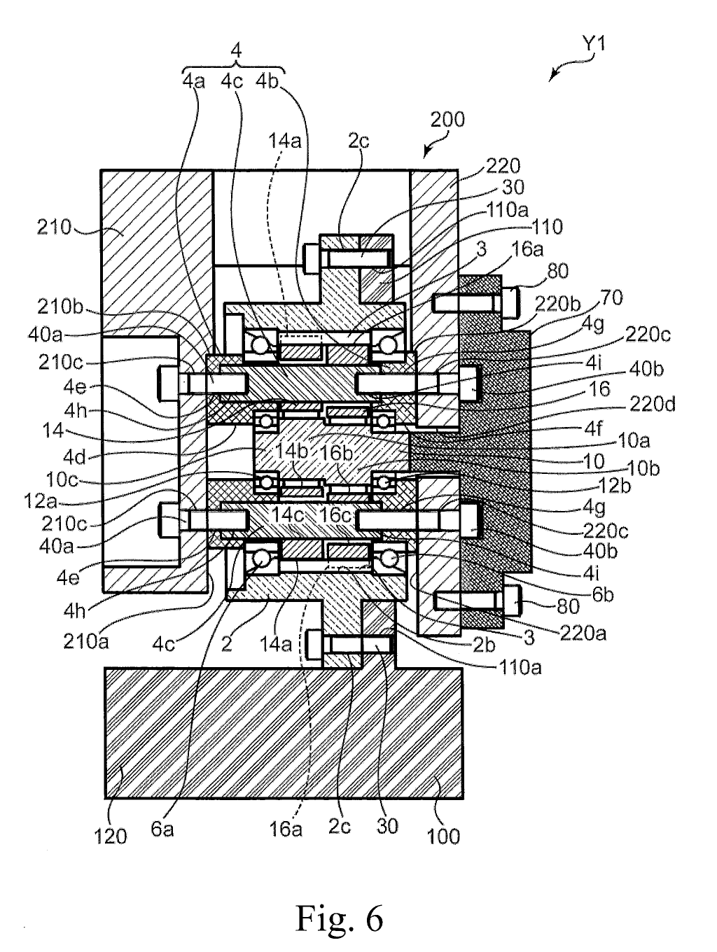

FIG. 6 illustrates Modification Example 3 of the joint mechanism Y1. In Modification Example 3, a flat servo motor 70 is used instead of the input section 11. The flat servo motor 40 is fixed to the second portion 220 by a plurality of forth fixing members 80. The flat servo motor 70 may have a plurality of dents in the surface that faces the external wall of the second portion 220 and each dent receives a screw head of each second fixing member 40. Since the flat servo motor 70 is provided in Modification Example 3 of the joint mechanism Y1 shown in FIG. 6, it is possible to increase the accuracy of the stop position. Moreover, since the flat servo motor 70 is fixed to the second portion 220, the motor that transmit a drive force to the crank shaft 10 can be integrated to the second member 200.

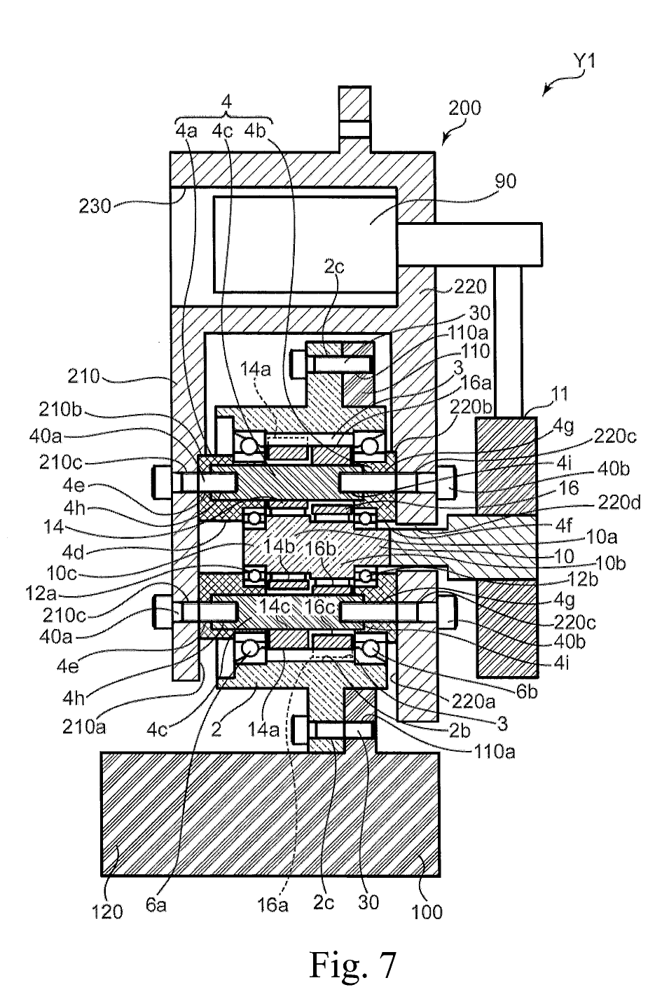

In order to integrate the second member 200 and the motor that transmit a drive force from the crank shaft 10, in addition to Modification Example 3 of FIG. 6, a motor 90 may be housed within a housing 230 provided in the second member 200 and the motor 90 may be coupled to the input section 11 to transmit the drive force from the motor 90 to the crank shaft 10 via the input section 11 as illustrated in Modification Example 4 of FIG. 7.

In Modification Examples 3, 4 of FIGS. 6 and 7, the motor (the flat servo motor 70, the motor 90) that provides a drive force to the crank shaft 10 is attached to the second member 200. In this manner, provided is a module including the first member 100 and the second member 200 that form a part of the humanoid robot X1, the gear device 300 that allows the first member 100 and the second member 200 to rotate relative to each other, and a motor (the flat servo motor 70, the motor 90) that provides a drive force to the gear device 300. When the module according to Modification Examples 3, 4 of the joint mechanism Y1 illustrated in FIGS. 6 and 7 are applied to a pair of elbows of the single humanoid robot X1, it is possible to improve the assembling process efficiency or to reduce the number of components of the humanoid robot X1. The module may also be applied to any other parts in, for example, a pair of hip or knee joints, that has a similar axial orientation or positional configuration as the pair of elbows.

The gear device 300 used in the embodiment and Modification Examples 1-4 of the joint mechanism 300 is a center-crank type gear device in which the shaft line of the shaft body 10c of the crank shaft 10 coincides the central axis line of the gear device 300. However, the invention is not limited to this. For instance, instead of the crank shaft 10, a plurality of crank shafts that are arranged circumferentially and radially in the gear device 300 at a regular interval from the central axis line of the gear device 300 may be provided. Alternatively, in addition to the crank shaft 10, the plurality of crank shafts arranged circumferentially may be provided. The number and arrangements of the crank shaft(s) 10 are not limited and they may be adequately changed in accordance with an application of the gear device 300.

Overview of the embodiment and Modification Examples 1-4 will be now described.

A joint mechanism of a humanoid robot according to the embodiment includes: a first member that forms a first region of the humanoid robot; a second member that forms a second region of the humanoid robot and includes first and second portions which face to each other; and a gear device. The gear device includes: a crank shaft on which an eccentric portion is formed; an oscillating gear that has external teeth and an insertion hole into which the eccentric portion is inserted; a carrier that retains the crank shaft rotatably; and an external cylinder that is disposed on radially outer side of the carrier and that has internal teeth meshing with the external teeth of the oscillating gear. The carrier and the external cylinder are configured to be displaced coaxially and relatively to each other due to oscillation of the oscillating gear that is generated by rotation of the crank shaft, and the gear device is disposed between the first portion and the second portion. The joint mechanism further includes a first fixing member that fixes the external cylinder to the first member; and a second fixing member that fixes the carrier to the second member. The second fixing member includes a one-side fixing member that fixes the carrier to the first portion of the second member and an other-side fixing member that fixes the carrier to the second portion of the second member.

In the joint mechanism of the humanoid robot described above, the first portion and the second portion of the second member face to each other, and the gear device is disposed between the first portion and the second portion. The carrier of the gear device is fixed to the first portion by the one-side fixing member, and the carrier of the gear device is fixed to the second portion by the other-side fixing member. In other words, the carrier of the gear device is fixed to the second member at its both ends in the axial direction. Therefore, it is possible to increase the torque that is transmitted to the second member via the rotation of the carrier. Moreover, the joint mechanism of the humanoid robot adapts, as the reducer, the gear device in which the carrier and the external cylinder are displaced coaxially and relatively to each other due to the oscillation of the oscillating gear that is rotated by the crank shaft. This gear device can endure a high load comparing to the strain wave gearing described in Patent Document 1 so that it is possible to prevent a decrease in the torque due to teeth skipping or buckling caused by the high load.

It is preferable that the oscillating gear has a through-hole that penetrates the oscillating gear in the axial direction. The carrier preferably includes a basal plate that faces the first portion, an end plate that faces the second portion and opposes the basal plate with the oscillating gear interposed therebetween, and a shaft that has a smaller diameter than that of the through-hole, at least a part of the shaft is situated in the through-hole to connect the basal plate and the end plate. In this case, it is preferable that the basal plate, the end plate, and the shaft be formed from separate members.

In the above-described humanoid robot joint mechanism, the shaft is inserted in the through-hole of the oscillating gear and then the basal plate and the end plate are arranged so as to sandwich the oscillating gear, and finally the shaft is connected to the basal plate and the end plate. In this way, the joint mechanism can be easily assembled. Moreover, in the joint mechanism that has such a configuration, the shaft, the basal plate, and the end plate may be formed from different materials from each other. For instance, the shaft may be formed from a highly rigid material since a high load is applied to the shaft, and the basal plate and the end plate may be formed from a relatively light-weight material. Therefore it is possible to provide the carrier with a high strength and light weight.

It is preferable that the one-side fixing member fix the shaft to the basal plate and the other-side fixing member fix the shaft to the end plate.

In the above-described joint mechanism of the humanoid robot, the one-side fixing member can fix the carrier to the first portion of the second member and can fix the shaft to the basal plate. Moreover, the other-side fixing member can fix the carrier to the second portion of the second member and can fix the shaft to the end plate. According to the joint mechanism of the humanoid robot described above, it is possible to connect the shaft to the basal plate and the end plate without increasing the number of components or assembling processes.

It is preferable that the basal plate and the end plate be made of a material with a smaller density compared to that of the shaft.

In the joint mechanism of the humanoid robot described above, the basal plate and the end plate are made of a light-weighted material with a density smaller than that of the shaft. Therefore it is possible to achieve weight saving of the whole carrier without impairing the rigidity of the shaft.

In the joint mechanism of the humanoid robot described above, it is preferable that a plate-like member be provided to fill at least one or both of a gap between the carrier and the first portion or a gap between the carrier and the second portion.

In the joint mechanism of the humanoid robot described above, even when the length of the carrier in the axial direction is smaller than the distance between the first portion and the second portion, the plate-like member can be provided to fill a gap between the carrier and at least one of the first portion or the second portion in the axial direction. Therefore, the distance between the first portion and the second portion is not necessary adjusted in accordance with the size of the gear device, and consequently it is possible to increase the assembling efficiency of the joint mechanism.

It is preferable that the first and second portions have guide portions respectively that guide the gear device to be inserted between the first portion and the second portion and that stop the insertion of the gear device at a predetermined position. In this case, it is preferable that the second fixing member fix the carrier to the second member at the predetermined position.

In the humanoid robot joint mechanism described above, the guide portion that guides the gear device to be inserted is provided on the first portion and the second portion respectively. The guide portion stops the insertion of the gear device at the predetermined position where the carrier is fixed to the second member. Therefore the carrier and the second member can be securely positioned relative to each other when the carrier is fixed to the second member through the second fixing member. Consequently it is possible to improve the assembling efficiency of the joint mechanism.

In the humanoid robot joint mechanism described above, preferably provided is a motor that is attached to the second member to transmit a drive force to the crank shaft to rotate the crank shaft.

In the humanoid robot joint mechanism described above, the motor that provides a drive force to rotate the crank shaft to the crank shaft is attached to the second member. In this manner, provided is a module including the first member and the second member that respectively form a part of the humanoid robot, the gear device that allows the first member and the second member to rotate relative to each other, and a motor that provides a drive force to the gear device. When this module is applied to a plurality of joints that have a relatively similar structure to each other, it is possible to improve the efficiency of the assembling process or to reduce the number of components of the humanoid robot. The joints that have a relatively similar structure in the single humanoid robot refers to any joints that have a similar axial orientation or positional configuration from each other and an example of such a joint may include a pair of hip joints, a pair of knee joints, and a pair of elbow joints.

1. A joint mechanism of a humanoid robot, comprising:
a first member forming a first region of the humanoid robot;
a second member forming a second region of the humanoid robot, the second including first and second portions that face to each other;
a gear device including a crank shaft on which an eccentric portion is formed, an oscillating gear that has external teeth and an insertion hole into which the eccentric portion is inserted, a carrier that retains the crank shaft rotatably, and an external cylinder that is disposed on radially outer side of the carrier and that has internal teeth meshing with the external teeth of the oscillating gear, the carrier and the external cylinder being configured to be displaced coaxially and relatively to each other due to oscillation of the oscillating gear that is generated by rotation of the crank shaft, and the gear device being disposed between the first portion and the second portion;
a first fixing member fixing the external cylinder to the first member; and
a second fixing member fixing the carrier to the second member,
wherein the second fixing member includes a one-side fixing member that fixes the carrier to the first portion of the second member and an other-side fixing member that fixes the carrier to the second portion of the second member.

2. The joint mechanism of a humanoid robot according to claim 1, wherein
the oscillating gear has a through-hole that penetrates the oscillating gear in its axial direction,
the carrier includes a basal plate that faces the first portion, an end plate that faces the second portion and opposes the basal plate with the oscillating gear interposed therebetween, and a shaft that has a smaller diameter than that of the through-hole, at least a part of the shaft is situated in the through-hole to connect the basal plate and the end plate, and
the basal plate, the end plate, and the shaft are formed from separate members.

3. The joint mechanism of a humanoid robot according to claim 2, wherein
the one-side fixing member fixes the shaft to the basal plate, and
the other-side fixing member fixes the shaft to the end plate.

4. The joint mechanism of a humanoid robot according to claim 2, wherein
the basal plate and the end plate are made of a material with a smaller density compared to that of the shaft.

5. The joint mechanism of a humanoid robot according to claim 1, further comprising:
a plate member provided to fill at least one or both of a gap between the carrier and the first portion or a gap between the carrier and the second portion.

6. The joint mechanism of a humanoid robot according to claim 1, wherein
the first and second portions each have a guide portion that guides the gear device to be inserted in a space between the first portion and the second portion and that stops the insertion of the gear device at a predetermined position, and
the second fixing member fixes the carrier to the second member at the predetermined position.

7. The joint mechanism of a humanoid robot according to claim 1, further comprising:
a motor attached to the second member to transmit a drive force to the crank shaft to rotate the crank shaft.
